(19) United States
(12) Patent Application Publication
(10) Pub. No.: US 2025/0284464 A1
(43) Pub. Date: Sep. 11, 2025

(54) FUNCTION SPLITTING FOR DATA COLLABORATION

(71) Applicant: INTERNATIONAL BUSINESS MACHINES CORPORATION, ARMONK, NY (US)

(72) Inventors: Dinesh C. Verma, New Castle, NY (US); Jonathan Lenchner, Greenwich, CT (US); Shiqiang Wang, White Plains, NY (US)

(21) Appl. No.: 18/599,548

(22) Filed: Mar. 8, 2024

(51) Int. Cl. G06F 7/58

(52) U.S. Cl. CPC G06F 7/588

(57) ABSTRACT

Described are techniques for secure collaboration among clients of a computing service. The techniques include distributing, to a set of clients, a first function of a function split to be performed by individual clients included in the set of clients on individually owned datasets to generate individual results. The techniques further include distributing, to the set of clients, a distortion function to be performed by the individual clients on the individual results of the first function to generate distorted results. The techniques further include receiving, from the set of clients, the distorted results of the first function generated by the individual clients. The techniques further include performing a second function of the function split using the distorted results of the first function to produce a return result.

### BACKGROUND

The present disclosure relates to computing, and, more specifically, to cloud computing services.

Cloud computing services are a collection of computing resources and applications, including software, infrastructure, and platforms. These computing services can be hosted by third-party providers, and the computing services can be delivered to clients through one or more computer networks (e.g., the Internet, wide area networks (WANs), etc.). Illustratively, a cloud computing service can interface with clients to receive, process, and analyze datasets; and provide the results back to the clients.

### SUMMARY

Aspects of the present disclosure are directed toward a computer-implemented method comprising distributing, to a set of clients, a first function of a function split to be performed by individual clients included in the set of clients on individually owned datasets to generate individual results. The computer-implemented method further comprising distributing, to the set of clients, a distortion function to be performed by the individual clients on the individual results of the first function to generate distorted results. The computer-implemented method further comprising receiving, from the set of clients, the distorted results of the first function generated by the individual clients. The computer-implemented method further comprising performing a second function of the function split using the distorted results of the first function to produce a return result.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1A and FIG. 1B are block diagrams of example systems that can implement collaborative computing utilizing a function split, in accordance with some embodiments of the present disclosure.

FIG. 2 is a sequence diagram illustrating an example technique for collaborative computing using a function split, a pairwise random number function, and the components described in association with FIG. 1A and FIG. 1B, in accordance with some embodiments of the present disclosure.

FIG. 3 is a sequence diagram illustrating another example technique for collaborative computing using a function split, a distortion function using a common random number, and the components described in association with FIG. 1A and FIG. 1B, in accordance with some embodiments of the present disclosure.

FIG. 4 is a sequence diagram illustrating another example technique for collaborative computing using a function split, a second function approximation, and the components described in association with FIG. 1A and FIG. 1B, in accordance with some embodiments of the present disclosure.

FIG. 5 is a flow diagram illustrating an example method for collaborative computing using a function split from a computing service perspective, in accordance with some embodiments of the present disclosure.

FIG. 6 is a flow diagram illustrating an example method for collaborative computing using a function split from a client perspective, in accordance with some embodiments of the present disclosure.

FIG. 7 is a block diagram that illustrates an example computing environment in which aspects of the present disclosure can be implemented, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward a function split to allow secure data collaboration among clients of a computing service. While not limited to such applications, embodiments of the present disclosure may be better understood in light of the aforementioned context.

Data collaboration between entities involves the sharing and analysis of data to achieve mutually beneficial goals. An entity could be a business, an organization, a nation, a branch of a business, or an individual or some other group depending on the context. Computing a function over combined data from different entities can uncover hidden patterns and trends that wouldn't be apparent from computing the function over individual entity datasets. This can lead to improved decision making, innovation, and problem solving. Cloud service providers offer resources and tools to facilitate data collaboration among entities (e.g., businesses and organizations). For example, cloud computing provides a secure and scalable platform for data storage and sharing. Application programming interfaces (APIs) facilitate secure data exchange between entities and cloud service providers. When using a cloud computing service, each entity is a client of the cloud computing service. Data visualization tools can be used to analyze and communicate the insights from the collaborative data efforts.

However, sharing data among entities and cloud service providers raises concerns about protecting individual data privacy and preventing unauthorized data access, as well as complying with strong data governance practices. As one example, financial institutions may wish to collaborate to gain insights into the financial industry, but may not be willing to share their individual datasets with one another and a cloud service provider. As another example, healthcare organizations may want to collaborate to compare recovery rates and financial performance with other healthcare organizations, but may not want to publicly share their datasets with each other and a cloud service provider. Another consideration is data volume, where sharing large amounts of data between organizations is unfeasible. For example, research labs that generate large amounts of data may wish to collaborate to share insights with one another, but due to the large amount of data involved, it would be impractical to move the data to a shared volume.

Advantageously, aspects of the present disclosure overcome the challenges described above by splitting a function being computed over all the datasets from multiple entities into a first function and a second function to enable collaboration among entities without sharing of their individual datasets. More specifically, aspects of the present disclosure split the computation of a function into two portions, a first function and a second function. The first and second functions are defined so that: the first function can be performed by each participating entity individually using their own dataset and computing resources; and the second function can be computed by a computing service (e.g., a cloud computing service) using the individual results of the first function provided by the individual entities.

Also, the second function is defined so that the computing service does not learn the individual results of the first function provided by the individual entities. That is, the second function can be constructed to prevent the computing service from learning the raw values of the individual results of the first function when calculating the second function. This can be accomplished by distorting the value of each individual result of the first function in a coordinated manner, such that when the second function is performed on the distorted values, the second function provides a return value that is substantially undistorted, or the distortion can be removed from the return value by the participating entities, as described in greater detail herein.

Aspects of the present disclosure distribute the first function of the function split to a set of computing devices associated with the participating entities. Each such computing device is a client of the computing service. Additionally, a distortion function for distorting the results of the first function is also distributed to the set of clients. Each client individually performs the first function on its own dataset to obtain an individual result, and then individually performs the distortion function to distort the value of the individual result. Each client then sends the distorted result of the first function to the computing service. In response, the computing service performs the second function of the function split on the distorted results of the first function provided by the set of clients. For some computations, by way of the coordinated manner in which the results of the first function are distorted, performance of the second function produces an undistorted return result, which the computing service then provides to the set of clients. For other computations, the performance of the second function produces a distorted result and the clients remove the distortion individually from the result provided by the computing service.

Advantageously, the aspects of the present disclosure are an improvement in the technical field of collaborative computing. As one advantage, the aspects of the present disclosure improve data privacy in collaborative computing by defining both: a function split to enable local dataset processing by clients that does not require sharing of individually owned datasets among participating clients and a computing service, and a distortion function to secure the individual results of the first function computed by the clients so that the computing service does not learn the raw values of the individual results. As another advantage, the aspects of the present disclosure improve collaborative computing that involves large datasets by defining a function split that enables local processing of a large dataset, such that the large dataset is not transferred to a shared volume, thereby decreasing an amount of network bandwidth and data storage used to transfer data between clients and a computing service, which consequently, decreases an overall amount of time to compute a return result of the second function of the function split.

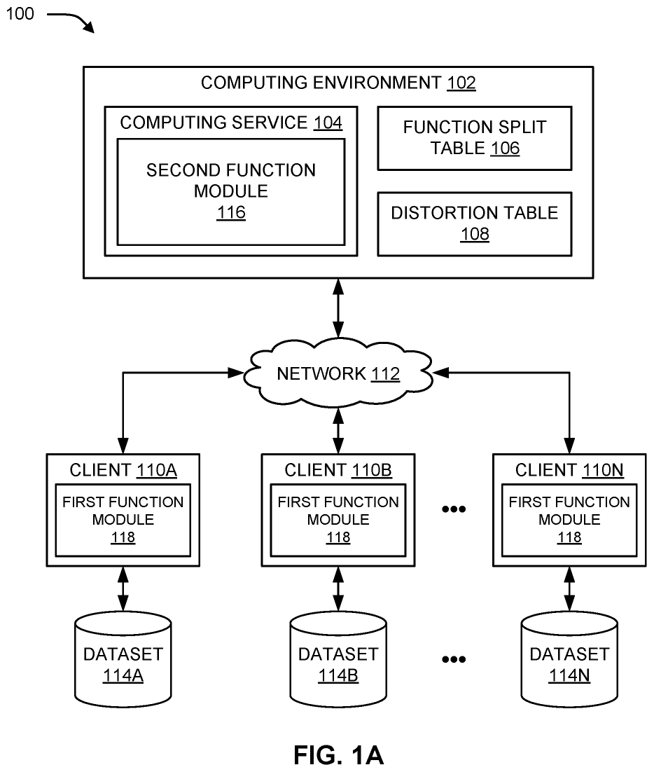

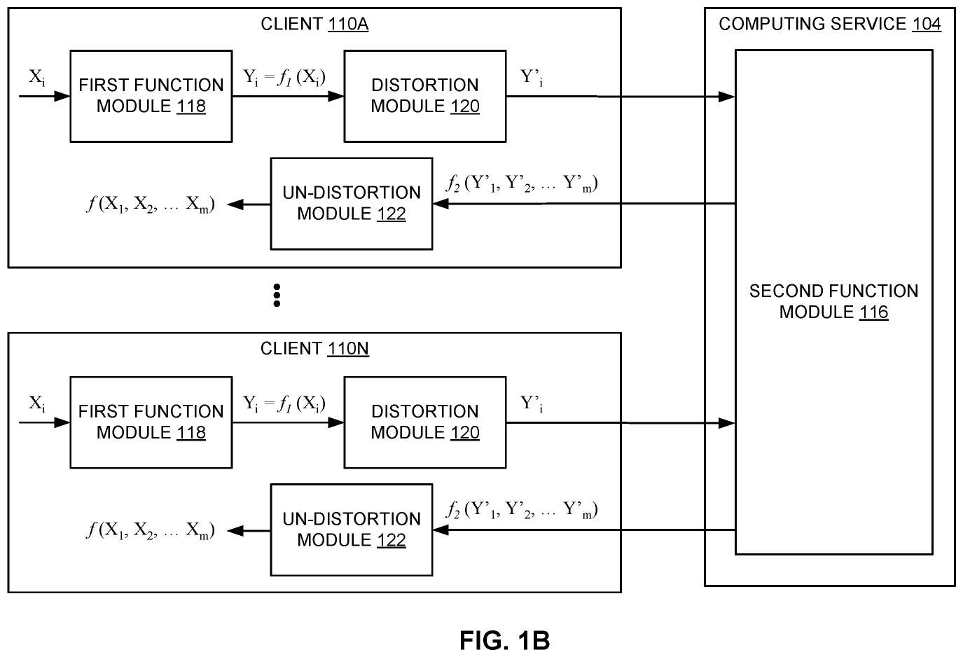

Referring now to the figures, FIG. 1A illustrates a block diagram of an example system 100 that can implement collaborative computing utilizing a function split, in accordance with some embodiments of the present disclosure. As shown, a computing environment 102 hosts a computing service 104 configured to provide collaborative computing using a function split. In some embodiments, the computing service 104 can be provided by a third-party provider (cloud service provider) to its customers. The computing service 104 can comprise software, infrastructure, and/or platform for coordinating and executing aspects of a function split.

The computing service 104 is connected via network 112 with a set of clients 110A, 110B, 110N (collectively 110, where N can refer to any positive integer representing any number of clients). As used herein, when used with reference to items, “a set of” means one or more of the items. For example, a set of clients is one or more different types of clients. A client 110 can comprise a hardware device and/or software capable of communicating with the computing service 104 over a network 112, and includes (or has access to) computing resources sufficient to perform a first function of a function split. The set of clients 110 interface with the computing service 104 (and with each other in some embodiments) for the purpose of data collaboration between entities associated with the individual clients 110. Each client 110 can be associated with a particular entity (e.g., a research laboratory, a government agency, a healthcare organization, a financial institution, a university, etc.) and can access a dataset 114A, 114B, 114N (collectively 114, where N can refer to any positive integer representing any number of datasets) owned by the entity. For example, a first client 110A can be associated with a first entity and access a dataset 114A owned by the first entity; a second client 110B can be associated with a second entity and access a dataset 114B owned by the second entity; and a third client 110N can be associated with a third entity and access a dataset 114N owned by the third entity. A dataset 114 can comprise any type and/or amount of data.

As mentioned, the system 100 enables data collaboration among entities using a function split. As referred to herein, a function split is the splitting (dividing) of a computation into a plurality of portions that can be distributed to, and performed by, a plurality of different computers associated with different entities. For example, a function ƒ (X₁, X₂, . . . Xₘ) can be split into two portions, a first function ƒ₁ (Xᵢ) and a second function ƒ₂ (Y₁, Y₂, . . . Yₘ). Suppose there are M entities and correspondingly M clients 110 and with a first client having access to dataset X₁, a second client having access to dataset X₂, and so on. The first and second functions can be defined so that: the first function ƒ₁ (Xᵢ) can be performed by each participating client 110 individually on its own dataset 114 with ƒ₁ (Xᵢ) producing the result Yᵢ; and the second function ƒ₂ (Y₁, Y₂, . . . Yₘ) can be computed by the computing service 104 using the individual results Yᵢ of the first function computed by the individual clients 110. Table 1 provides a non-limiting and non-exclusive list of example functions that can be split into first and second functions.

TABLE 1

| Function f | Function f₁ | Function f₂ |
|---|---|---|
| Mean | Mean, and Counts | Weighted mean with weight |
| | | as number of counts at |
| | | each entity |
| Sum | Sum | Sum |
| Min | Min | Min |
| Max | Max | Max |
| Standard Deviation | Variance | Weighted Sum |
| Neural Network | Neural Network | Weight Aggregation |
| Training | Training | |

Also, in some embodiments, the second function ƒ₂ (Y₁, Y₂, . . . Yₘ) of the function split can be defined so that the computing service 104 does not learn the individual results Yᵢ of the first function ƒ₁ (Xᵢ) computed by the individual clients 110. That is, the second function is defined so that the computing service 104 can compute the second function without learning the raw value of the individual results of the first function. This can be accomplished by adding noise to the individual values of Yᵢ to obtain Y′ᵢ. The noise can be coordinated among the clients 110 using a distortion function so that the second function performed by the computing service 104 is ƒ₂ (Y′₁, Y′₂, . . . Y′ₘ).

As an illustration, an entity (e.g., a government agency) may wish to collaborate with similar entities (e.g., international government agencies) to compare information (e.g., health-data statistics) without having to share their raw data with each other and the computing service 104. The entities can secure the privacy of their own data by individually computing the first function of the function split using their own computing resources (clients 110) and dataset(s) 114, and collaborating with one another to distort their individual results of the first function using a distortion function prior to sending the individual results to the computing service 104. The computing service 104 can then perform the second function using the individual distorted results. As will be described in more detail later, based on the computation performed by the second function, the distortion can be removed (or substantially removed) in a return value of the second function, or the distortion can be removed from the return value of the second function by the individual clients 110 after receiving the return value from the computing service 104.

In some embodiments, a computation performed by the second function (e.g., addition, multiplication, secure average, etc.) determines which distortion function to employ to distort the individual results of the first function. Table 2 provides a non-limiting and non-exclusive list of distortion functions that can be used to distort the raw values of individual results of a first function computation performed by the clients 110.

TABLE 2

| f₂ | Distortion function |
|---|---|
| Addition | Pairwise random number addition to each |
| | client so that the sum cancels out. |
| Multiplication | Pairwise multiplication by each client |
| | so that the product results in unity. |
| Maximum/Minimum | A common random number to be added by |
| | each client. |
| Secure Average | Two random numbers, one for pairwise |
| | addition so that sum cancels out, and |
| | the other shared across all clients to |
| | be added. |

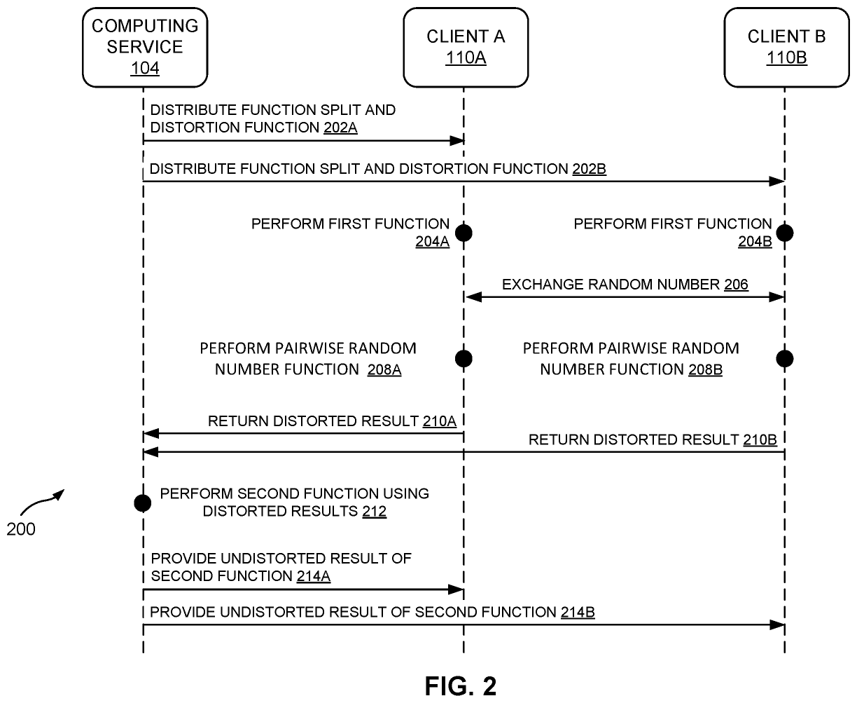

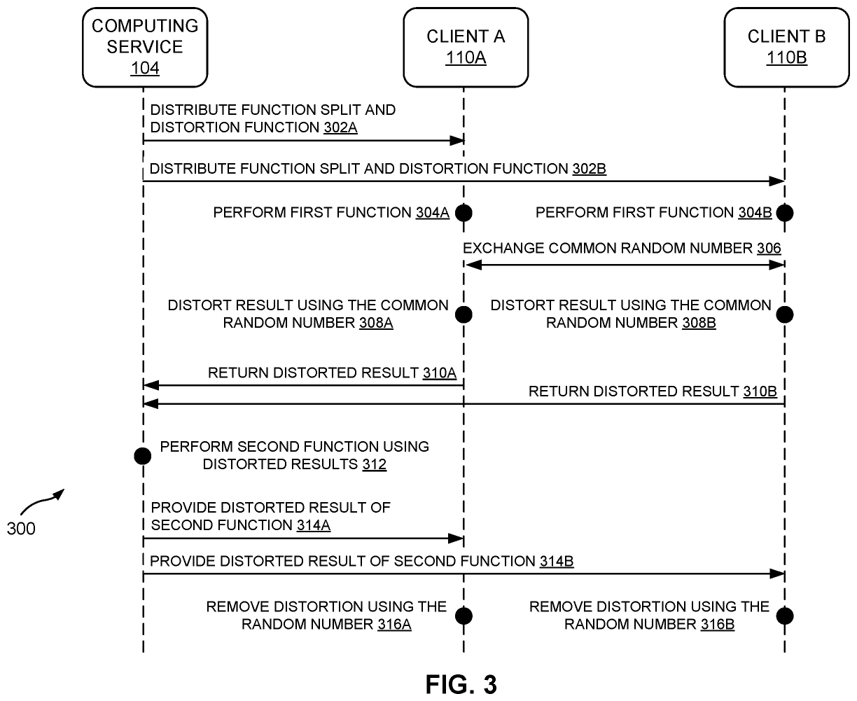

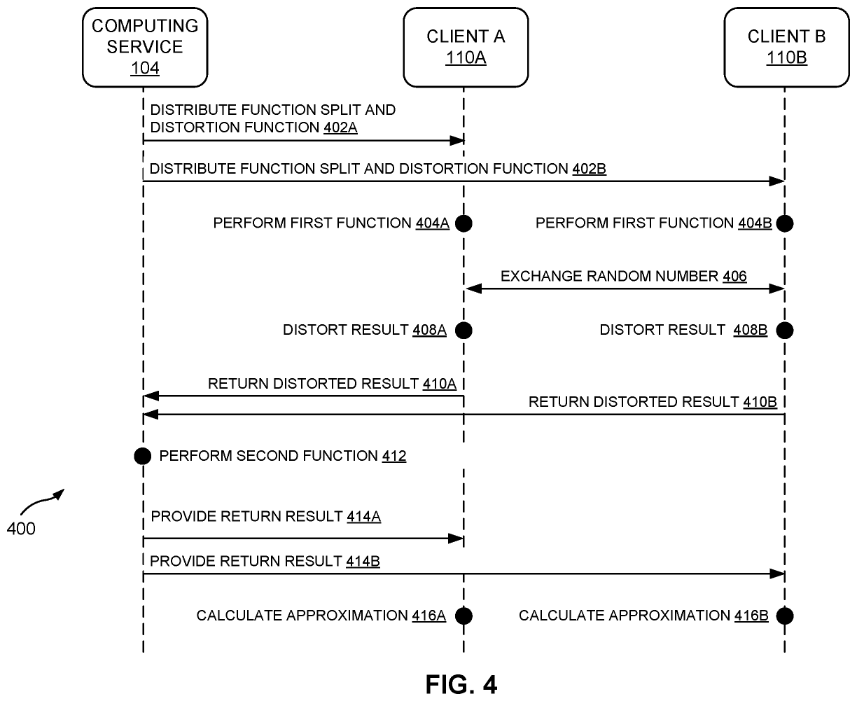

For second function computations involving addition and/or multiplication, a distortion function can be used to add random noise to individual results of the first function that cancels out when the second function is performed. A more detailed description of this concept will be provided later in association with FIG. 2. For a second function involving maximum/minimum computations, a common random number can be used to distort the individual results of the first function, and the clients 110 can remove the distortion from a return value of the second function using the common random number. A more detailed description of this concept will be provided later in association with FIG. 3. For a second function that computes a secure average, a second function approximation can be used, as is described in more detail in association with FIG. 4.

The computing service 104 can be provided to customers of a service provider, who can utilize the computing service 104 to collaborate without the need to share their individual datasets 114 with each other and the computing service 104. For example, collaborating entities can agree to use the computing service 104 to share insights derived from their individually owned data.

In some embodiments, the service provider can maintain a function split table 106 containing defined function splits for one or more computations (e.g., the functions shown in Table 1), and a distortion table 108 containing one or more defined distortion functions (e.g., the distortion functions shown in Table 2) for distorting the raw values of individual results of a first function computation. As part of a request to provide a collaborative computing service to collaborating entities (e.g., customers of the service provider), the computing service 104 distributes the function split table 106 and the distortion table 108 to clients 110 associated with the collaborating entities. The function split table 106 provides the clients 110 with a first function of a function split to be performed individually by each client 110 on a dataset 114 owned by the client 110. The distortion table 108 provides the clients 110 with a distortion function to be performed by the clients 110 on the individual results of the first function. In some embodiments, the function split table 106 and the distortion table 108 may be distributed to the clients by a process not involving the computing service 104, such as another computing service, or by one of the clients storing the tables and providing them to the other clients.

After receiving the function split table 106 and the distortion table 108 from the computing service 104, the clients 110 individually compute a first function defined in the function split table 106 and individually distort the results of the first function using a distortion function defined in the distortion table 108. After computing and distorting the individual results of the first function, the clients 110 send the individual results to the computing service 104.

In the embodiment illustrated in FIG. 1A, each client 110 includes a first function module 118 configured to perform a first function of a function split, distort the result of the first function, and provide the distorted result to the computing service 104. As an example, the first function module 118 obtains the first function from the function split table 106, obtains a dataset 114 owned by a client 110 that hosts the first function module 118, and performs the first function computation on the dataset 114.

FIG. 1B illustrates that in addition to the first function module 118, each client 110 can include a distortion module 120 and an un-distortion module 122. In this embodiment, after performing the first function, the distortion module 120 distorts the result of the first function computation using a distortion function defined in the distortion table 108. As will be described in detail in association with FIG. 2 and FIG. 3, in some embodiments, the clients 110 (via the distortion module 120) coordinate performance of the distortion function to add random noise to the individual results of the first function using a technique that cancels out (or substantially cancels out) the random noise when the second function is performed by the computing service 104. The distortion module 120 sends the distorted results of the first function to the computing service 104 to enable the computing service 104 to perform the second function of the function split.

The computing service 104 receives the individual distorted results of the first function from the clients 110 and performs a second function of the function split using the individual distorted results as inputs. Because the individual results of the first function are distorted, the computing service 104 does not learn the raw value of the individual results. As shown, the computing service 104 includes a second function module 116 configured to perform the second function of the function split and provide a return value of the second function to the individual clients 110. As mentioned earlier, in some embodiments, a distortion function used to distort the individual results of the first function can be designed so that performing the second function on the individual distorted results removes (or substantially removes) the distortion from the return value of the second function, as described below in association with FIG. 2. In other embodiments, the return value of the second function provided by the computing service 104 is distorted. In such embodiments, each client 110 can include an un-distortion module 122 (shown in FIG. 1B) that removes the distortion from the return value, as described below in association with FIG. 3.

The computing service 104 can be implemented in software, hardware, firmware or a combination thereof. When software is used, the operations performed by the computing service 104 can be implemented in program instructions configured to run on hardware, such as a processor unit. When firmware is used, the operations performed by the computing service 104 can be implemented in program instructions and data and stored in persistent memory to run on a processor. When hardware is employed, the hardware can include circuits that operate to perform the operations in the computing service 104. Moreover, aspects of the computing service 104 can be implemented using one or more modules. Generally, modules (also referred to as program modules) include routines, programs, components and/or data structures that perform particular tasks and/or implement particular abstract data types. The modules can provide a service application that receives requests and provides output to other services or devices. An API can be provided for each module to enable a first module to send requests to and receive output from a second module. Such APIs can also allow third parties to interface with the module and make requests and receive output from the modules.

A dataset 114 comprises a collection of data that can be used for various purposes, such as analysis, modeling, learning, visualization, etc. A dataset 114 can have different types, formats, and features depending on the domain and problem to be solved. Illustratively, a dataset 114 can include a numerical dataset, a categorical dataset, a time series dataset, and other types of datasets. A dataset 114 can be stored in various formats (e.g., comma separated value (CSV), JSON, extensible markup language (XML), etc.) and can comprise subsets.

The network 112 illustrated in FIG. 1A enables communication between the components of the system 100. The network 112 can include any useful computing network, including an intranet, the Internet, a local area network, a wide area network, a wireless data network, or any other such network or combination thereof. Components utilized for the network 112 can depend at least in part upon the type of network and/or environment selected. Communication over the network 112 can be enabled by wired or wireless connections and combinations thereof.

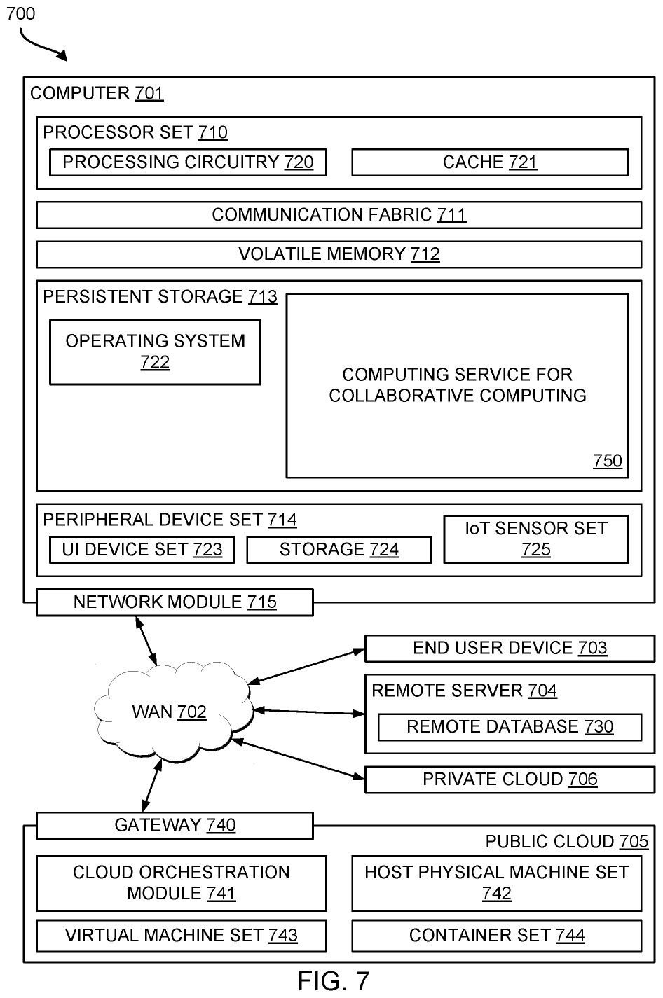

All or a portion of the system 100 shown in FIG. 1A and FIG. 1B can be implemented, for example by all or a subset of the computing environment 700 of FIG. 7. The illustration of the system 100 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. The example environments discussed and illustrated above are merely representative and are not meant to be limiting.

FIG. 2 is a sequence diagram illustrating an example technique 200 for collaborative computing using a function split, a pairwise random number function, and the components described in association with FIG. 1A and FIG. 1B, in accordance with some embodiments of the present disclosure. As described earlier, collaborating entities can agree to use a computing service 104 provided by a service provider to share insights derived from their individually owned data without the need to share their raw data with one another and the computing service 104. The technique 200 illustrated in FIG. 2 accomplishes this using a function split that divides a computation into a first function to be performed by each entity using their own data and client 110 (e.g., a computer owned by, or associated with, the entity), and a second function to be performed by the computing service 104 using the individual distorted results of the first function provided by the clients 110 of the entities.

As illustrated, the technique 200 includes operation 202A and operation 202B which distribute a function split and a distortion function to a set of clients, such as client 110A and client 110B (collectively 110), where the set of clients are associated with collaborating entities. As will be appreciated, although two clients 110A and 110B are shown in FIG. 2, any number of clients can participate in a data collaboration among entities. In the embodiment shown in FIG. 2, the computing service 104 distributes the function split and distortion function to the clients 110. In some embodiments, only the first function of the function split is distributed to the clients 110. As described earlier in association with FIG. 1A, in some embodiments, the computing service 104 can distribute a function split table and a distortion function table. Alternatively, in some embodiments, an entity other than the computing service 104 (e.g., one of the collaborating entities or an uninterested third-party) can provide the function split (e.g., or just the first function of the function split) and distortion function to the clients 110, and provide the function split (e.g., or just the second function of the function split) to the computing service 104. As will be appreciated, the distribution of the function split and/or distortion function can be done at any time prior to performance, and can be distributed separately from each other at different times.

In operation 204A, client 110A performs the first function of the function split on a dataset owned by client 110A; and in operation 204B, client 110B performs the first function of the function split on a dataset owned by client 110B. An amount of time to perform the first function by the clients 110 can vary. For example, because datasets can vary between entities, an amount of time to perform the first function on a dataset can be proportional to the size of the dataset. Also, the clients 110 can perform the first function in parallel (e.g., substantially at the same time), or at different times, as will be appreciated. For example, when clients 110 are geographically dispersed across time zones, a client 110A located in a first time zone (e.g., Mountain Standard Time) may start performance of the first function at a different time than that of a client 110B located in a second time zone (e.g., India Standard Time).

After a client 110 performs the first function of the function split, the client 110 then performs the distortion function to distort the raw value of the result, so as to prevent the computing service 104 from learning the raw value. As described earlier, the distortion function used to distort the result of the first function may be based on the computation to be performed by the second function by the computing service 104.

In this example, the computation performed by the second function is either of an aggregation computation or a multiplication computation, and the distortion function performed by the clients 110 is a pairwise random number function that adds random noise to the individual results of the first function. In some embodiments, the pairwise random number function includes dividing a set of clients into M(M−1)/2 pairs, and each pair of clients obtaining/generating a random number and exchanging the random number between them. In some embodiments, the set of clients coordinate this among themselves. Alternatively, in some embodiments, the computing service 104 can facilitate dividing the set of clients into pairs, and thereafter, each pair of clients coordinates among themselves to obtain and exchange a random number.

In the case that the second function to be performed by the computing service 104 is an aggregation computation, the pairwise random number function comprises: exchanging the random number between a first client (e.g., client 110A) and a second client (e.g., client 110B); and thereafter the first client adds the random number to the individual result generated by the first client; and the second client subtracts the random number from the individual result generated by the second client. In the case that the second function to be performed by the computing service 104 is a multiplication computation, the pairwise random number function comprises: exchanging the random number between a pair of clients comprising a first client (e.g., client 110A) and a second client (e.g., client 110B); and thereafter, the first client multiplies its individual result generated by the random number; and the second client device divides its individual result by the random number.

Accordingly, in anticipation of performing the pairwise random number function to prevent the computing service 104 from learning the raw results of the first function, a pair of clients (e.g., client 110A and client 110B) exchange a random number for use in performing the pairwise random number function, as shown in operation 206. As will be appreciated, the exchange of the random number can be performed at any time prior to performing the pairwise random number function. The random number can be obtained using any appropriate technique. In some embodiments, one of the pairwise clients (e.g., client 110A) can generate the random number and share the random number with the other pairwise client (e.g., client 110B). In some embodiments, the random number can be obtained from another entity other than the computing service 104 (so as to prevent the computing service 104 from learning the random number). As an example, the random number can be obtained from a quantum key distribution (QKD) network that uses a cryptographic protocol involving components of quantum mechanics to provide a random number. Illustratively, a QKD network enables two parties to produce a shared random number known only to them, which then can be used by the clients 110 to perform the pairwise random number function.

The exchange of the random number between the clients 110 in operation 206 allows the clients 110 to also coordinate performance of the pairwise random number function. For example, as part of the exchange of the random number, a first client (e.g., client 110A) can be selected to add/multiply its result by the random number, and a second client (e.g., client 110B) can be selected to subtract/divide its result by the random number. The selection of the first and second clients can be performed using any appropriate selection technique, such as a leader election algorithm.

In order to illustrate the performance of the pairwise random number function, assume that client 110A is selected to add/multiply (as determined by the computation of the second function to be performed) its result by the random number, and client 110B is selected to subtract/divide (as also determined by the computation of the second function to be performed) its result by the random number. Accordingly, after exchanging the random number and coordinating performance of the pairwise random number function, in operation 208A, client 110A performs the pairwise random number function by adding/multiplying its result of the first function by the random number to generate an individual distorted result; and in operation 208B, client 110B performs the pairwise random number function by subtracting/dividing its result of the first function by the random number to generate an individual distorted result.

In operation 210A, client 110A sends its individual distorted result to the computing service 104, and in operation 210B, client 110B also sends its individual distorted result to the computing service 104. After receiving the individual distorted results from the clients 110, in operation 212, the computing service 104 performs the second function of the function split. Performing the second function using the distorted results of the first function cancels out the distortion in a return value generated by the second function. That is, when the second function comprises an aggregation computation, the pairwise random number addition/subtraction performed by the clients 110 results in the distortion to cancel out in the sum of the aggregation computation. When the second function comprises a multiplication computation, the pairwise random number multiplication/division performed by the clients 110 results in the product of the multiplication computation to be unity.

After performing the second function of the function split, the computing service 104, in operation 214A sends the return value generated by the second function to client 110A, and in operation 214B sends the return value to client 110B. Accordingly, each of the clients 110 receives the undistorted return value derived from the individually owned datasets without sharing of any raw data among the clients 110 and the computing service 104.

FIG. 3 is a sequence diagram illustrating another example technique 300 for collaborative computing using a function split, a distortion function using a common random number, and the components described in association with FIG. 1A and FIG. 1B, in accordance with some embodiments of the present disclosure. Similar to the embodiments described above, operations 302A and 302B distribute a function split and a distortion function to a set of clients (client 110A and client 110B) associated with collaborating entities. As will be appreciated, although two clients 110A and 110B (collectively 110) are shown in FIG. 3, the set of clients can include any number of clients. In operation 304A, client 110A performs the first function of the function split on a dataset owned by client 110A; and in operation 304B, client 110B performs the first function of the function split on a dataset owned by client 110B.

In operation 306, the clients 110 exchange a common random number for use in performing a random number function. The common random number is provided to each client 110 included in the set of clients, such that, for example, if a set of clients includes two, five, ten, or more clients, each client in the set is provided with the common random number. As will be appreciated, the exchange of the common random number can be performed at any time prior to performing the distortion function, and the common random number can be obtained using any appropriate technique. In some embodiments, one of the clients 110 can generate the common random number and share the random number with all the other clients 110 included in the set of clients. In some embodiments, one of the clients in the set of clients can obtain the common random number from another entity (e.g., a QKD network) other than the computing service 104 (so as to prevent the computing service 104 from learning the random number) and share the common random number with the other clients in the set of clients.

In operations 308A and 308B, the clients 110 distort their individual results of the first function by applying the common random number to their results. As one example, each client 110 adds the common random number to its result of the first function, such that client 110A adds the common random number to its result, and client 110B adds the common random number to its result. As another example, each client 110 subtracts the common random number to its result of the first function, such that client 110A subtracts the common random number from its result, and client 110B subtracts the common random number from its result. Thereafter, in operations 310A and 310B, the clients 110 send their individual distorted results to the computing service 104.

After receiving the individual distorted results from the clients 110, in operation 312, the computing service 104 performs the second function of the function split and, in operations 314A and 314B, provides the return value to the clients 110. Unlike the return value described in association with FIG. 2, in which a pairwise random number function is designed to cancel out the distortion when the second function is performed, the distortion created using the common random number is not cancelled out when the second function is performed. Accordingly, the return value provided to the clients 110 is distorted, and the individual clients 110 remove the distortion from the return value received from the computing service 104 to obtain a true value.

Therefore, in operations 316A and 316B, each client 110 in the set of clients removes the distortion from the return value. For example, each client 110 uses the common random number to calculate a sum (e.g., by multiplying the common random number by the number of clients 110 included in the set of clients) and applies (e.g., adds or subtracts) the sum to the return value received from the computing service 104. As an example, in the case that both client 110A and client 110B individually added the common random number sixteen (16) to their individual results of the first function, the return value of the second function would increase by thirty-two (32). Therefore, when client 110A and client 110B receive the return value of the second function from the computing service 104, both client 110A and client 110B individually calculate a sum to subtract from the return value (common random number (16)*number of clients (2)=(32)).

FIG. 4 is a sequence diagram illustrating another example technique 400 for collaborative computing using a function split, a second function approximation, and the components described in association with FIG. 1A and FIG. 1B, in accordance with some embodiments of the present disclosure. As will be appreciated, although two clients 110A and 110B (collectively 110) are shown in FIG. 4, the technique 400 can be used with any number of clients. Again, similar to the embodiments described above, in operations 402A and 402B, a function split and a distortion function are distributed to a set of clients (client 110A and client 110B) associated with collaborating entities. In operations 404A and 404B, the clients 110A and 110B individually perform the first function of the function split on a dataset owned by a respective client. In operation 406, the clients 110 exchange a random number, and in operations 408A and 408B, the clients 110 distort their individual results of the first function by applying the random number to their results. The random number exchanged could be a common random number, or a set of numbers exchanged pairwise, or a number computed by using a subset of random numbers exchanged pairwise. Operations 404A, 404B, 408A, and 408B can be performed using any of the techniques previously described. Thereafter, in operations 410A and 410B, the clients 110 send their individual distorted results to the computing service 104.

In operation 412, the computing service 104 performs a second function which results in computing a function ƒ₂ and the derivatives of ƒ₂ with respect to the input provided by the each of the clients. The value of the function and its derivatives are sent back to the clients in operations 414A and 414B, which then compose the function and approximate it by the Taylor series expansion in operations 416A and 416B (e.g., using the un-distortion module 122 shown in FIG. 1B). By way of background, the Taylor series or Taylor expansion of a function is an infinite sum of terms that are expressed in terms of the function's derivatives at a single point. For most common functions, the function and the sum of its Taylor series are equal near this point. In the case that a higher degree of accuracy is desired, the second derivatives of the function can also be computed and used in a larger degree of the Taylor expansion.

In the illustrative examples above, the same reference numeral is used in more than one figure. This reuse of a reference numeral in different figures represents the same element in the different figures.

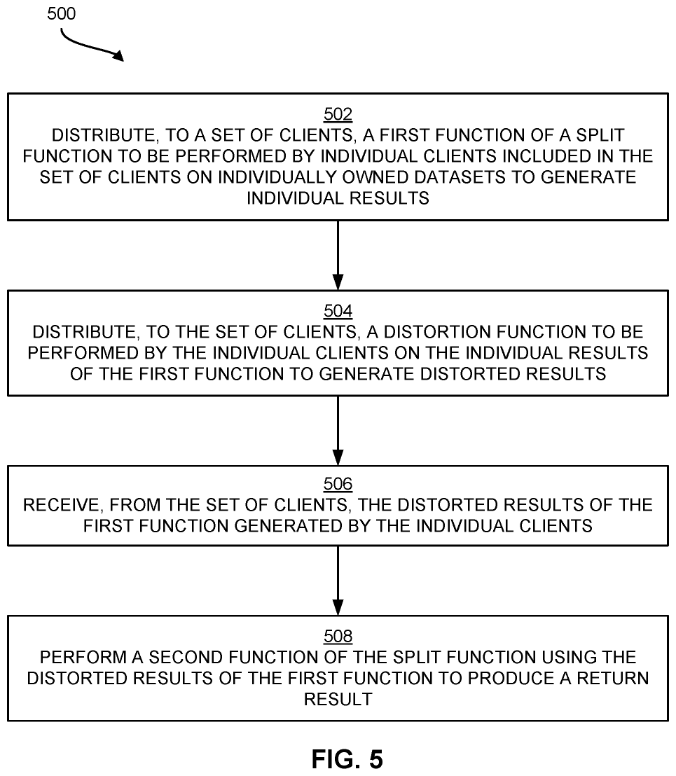

FIG. 5 is a flow diagram illustrating an example method 500 for collaborative computing using a function split from a computing service perspective, in accordance with some embodiments of the present disclosure. In operation 502, the method 500 distributes, to a set of clients, a first function of a function split to be performed by individual clients included in the set of clients on individually owned datasets to generate individual results. In operation 504, the method 500 distributes, to the set of clients, a distortion function to be performed by the individual clients on the individual results of the first function to generate distorted results. In some embodiments, the method 500 distributes a function split table and a distortion function table to the set of clients.

In operation 506, the method 500 receives, from the set of clients, the distorted results of the first function generated by the individual clients. In some embodiments, the set of clients coordinate performance of the distortion function to add random noise to the individual results of the first function.

As one example, the distortion function performed by the individual clients can be a pairwise random number function that includes: exchanging a random number between a pair of clients comprising a first and second client, adding, by the first client, the random number to an individual result generated by the first client using the first function, and subtracting, by the second client, the random number from an individual result generated by the second client using the first function.

As another example, the distortion function performed by the individual clients can be a pairwise random number function that includes: exchanging a random number between a pair of clients comprising a first and second client, multiplying, by the first client using the random number, an individual result generated by the first client using the first function, and dividing, by the second client using the random number, an individual result generated by the first client using the first function.

In yet another example, the distortion function performed by the individual clients uses a common random number that is provided to each individual client in the set of clients, where each individual client in the set of clients applies the common random number to the individual results of the first function to generate the distorted results, and each individual client in the set of clients uses the common random number to remove a distortion from the return result of the second function.

In operation 508, the method 500 performs a second function of the function split using the distorted results of the first function to produce a return result. In some embodiments, the return result of the second function performed by the computing service is an approximation. After performing the second function of the function split, the method 500 provides the return result of the second function to the set of clients.

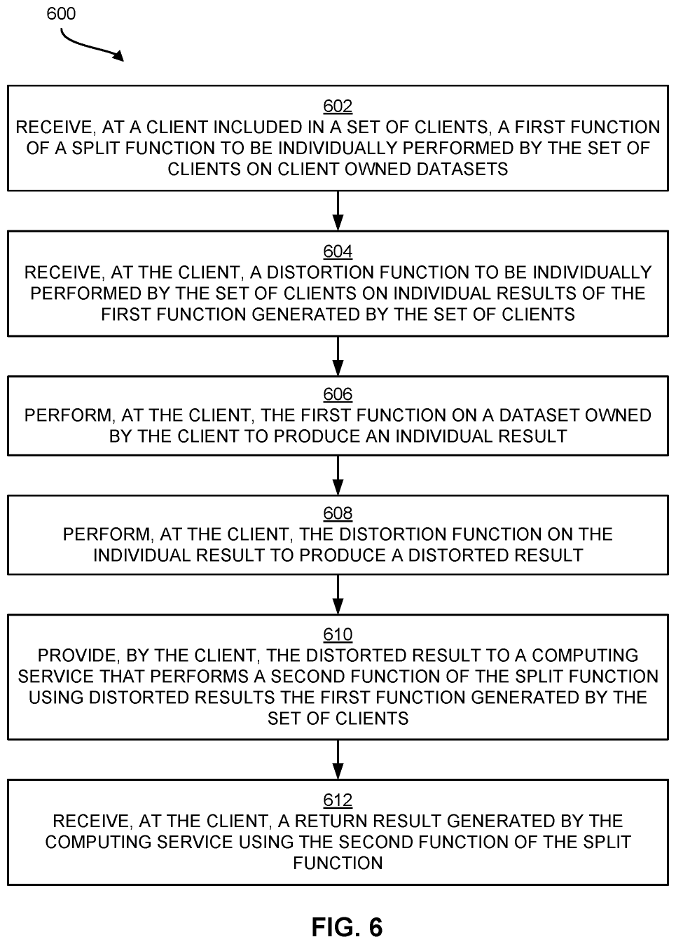

FIG. 6 is a flow diagram illustrating an example method 600 for collaborative computing using a function split from a client perspective, in accordance with some embodiments of the present disclosure. As described herein, clients associated with entities can interface with a computing service to securely share insights on their individually owned data using the function split. The method 600 allows a client of to participate in a data collaboration computation.

In operation 602, the method 600 receives, at a client included in a set of clients, a first function of the function split to be individually performed by the set of clients on client owned datasets. In operation 604, the method 600 receives, at the client, a distortion function to be individually performed by the set of clients on individual results of the first function generated by the set of clients.

In operation 606, the method 600 performs, at the client, the first function on a dataset owned by the client to produce an individual result. In operation 608, the method 600 performs, at the client, the distortion function on the individual result to produce a distorted result.

In some embodiments, as part of performing the distortion function, the client coordinates with other clients in the set of clients to add random noise to the individual results of the first function. As one example, the distortion function performed by the set of clients can be a pairwise random number function. In some embodiments, the pairwise random number function includes exchanging a random number between a pair of clients (a first client and a second client), where the first client adds the random number to its individual result of the first function, and the second client subtracts the random number from its individual result of the first function. In other embodiments of the pairwise random number function, the first client multiples its individual result of the first function by the random number, and the second client divides its individual result of the first function by the random number.

In some embodiments, the distortion function performed by the set of clients uses a common random number that is provided to each individual client in the set of clients, where each individual client in the set of clients applies the common random number to the individual results of the first function to generate the distorted results, and each individual client in the set of clients uses the common random number to remove a distortion from the return result of the second function.

In operation 610, the method 600 provides, by the client, the distorted result to the computing service which performs a second function of the function split using distorted results the first function generated by the set of clients. In operation 612, the method 600 receives, at the client, a return result generated by the computing service using the second function of the function split.

The methods 500 and 600 described above can be performed by a computer (e.g., computer 701 in FIG. 7), performed in a cloud environment (e.g., clouds 706 or 705 in FIG. 7), and/or generally can be implemented in fixed-functionality hardware, configurable logic, logic instructions, etc., or any combination thereof. In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code involved in performing the disclosed methods, such as a computing service configured for collaborative computing in block 750. In addition to block 750, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 750, as identified above), peripheral device set 714 (including user interface (UI), device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 721 and the other storage media discussed below. The computer readable program instructions, and associated data, are accessed by processor set 710 to control and direct performance of the disclosed methods. In computing environment 700, at least some of the instructions for performing the disclosed methods may be stored in block 750 in persistent storage 713.

COMMUNICATION FABRIC 711 is the signal conduction paths that allow the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, the volatile memory is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid-state storage devices. Operating system 722 may take several forms, such as various known proprietary operating systems or open-source Portable Operating System Interface type operating systems that employ a kernel. The code included in block 750 typically includes at least some of the computer code involved in performing the disclosed methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the disclosed methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

It will be further appreciated that various aspects of the present invention may be provided in the form of a service deployed on behalf of a customer to offer service on demand.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. The terms “comprises,” “comprising,” “includes,” “including,” “has,” “having,” “contains” or “containing,” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. The term “user” refers to an entity (e.g., an individual(s), a computer, or an application executing on a computer). It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. It is also to be understood that the term “substantially” as used herein with regard to the removal of data distortion is meant to denote being close or approximate to, but not exactly. For example, the term “substantially” as used herein implies a degree of accuracy of a return value, e.g., ±0.1%, ±0.5%, ±1%, etc.

In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure. Note further that numerous aspects or features are disclosed herein, and unless inconsistent, each disclosed aspect or feature is combinable with any other disclosed aspect or feature as desired for a particular application of the concepts disclosed.

As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art. Any advantages discussed in the present disclosure are example advantages, and embodiments of the present disclosure can exist that realize all, some, or none of any of the discussed advantages while remaining within the spirit and scope of the present disclosure.

The descriptions of the various aspects of the present invention have been presented for purposes of illustration, but are not intended to be exhaustive or limited to the approaches disclosed. Many modifications and variations will be apparent to those of ordinary skill in the art without departing from the scope and spirit of the described aspects. The terminology used herein was chosen to best explain the principles of the various aspects described, the practical application or technical improvement over technologies found in the marketplace, or to enable others of ordinary skill in the art to understand the approaches disclosed herein.

What is claimed is:

1. A system comprising:
one or more computer readable storage media storing program instructions and one or more processors which, in response to executing the program instructions, are configured to:
distribute, to a set of clients, a first function of a function split to be performed by individual clients included in the set of clients on individually owned datasets to generate individual results;
distribute, to the set of clients, a distortion function to be performed by the individual clients on the individual results of the first function to generate distorted results;
receive, from the set of clients, the distorted results of the first function generated by the individual clients; and
perform a second function of the function split using the distorted results of the first function to produce a return result.

2. The system of claim 1, wherein the program instructions are further configured to cause the one or more processors to:
provide the return result of the second function to the set of clients.

3. The system of claim 1, wherein the program instructions configured to cause the one or more processors to distribute the first function and the distortion function are further configured to cause the one or more processors to:
distribute a function split table and a distortion function table to the set of clients.

4. The system of claim 1, wherein the set of clients coordinate performance of the distortion function to add random noise to the individual results of the first function.

5. The system of claim 1, wherein the distortion function performed by the individual clients is a pairwise random number function comprising:
exchanging a random number between a pair of clients comprising a first client and a second client;
adding, by the first client, the random number to an individual result generated by the first client using the first function; and
subtracting, by the second client, the random number from an individual result generated by the second client using the first function.

6. The system of claim 1, wherein the distortion function performed by the individual clients is a pairwise random number function comprising:
exchanging a random number between a pair of clients comprising a first client and a second client;
multiplying, by the first client using the random number, an individual result generated by the first client using the first function; and
dividing, by the second client using the random number, an individual result generated by the second client using the first function.

7. The system of claim 1, wherein the distortion function performed by the individual clients uses a common random number that is provided to each individual client in the set of clients, wherein each individual client in the set of clients applies the common random number to the individual results of the first function to generate the distorted results, and each individual client in the set of clients uses the common random number to remove a distortion from the return result of the second function.

8. The system of claim 1, wherein the return result and derivatives of the return result are returned to the set of clients, and each individual client in the set of clients calculates an approximation using a Taylor series expansion function.

9. A computer-implemented method comprising:
receiving, at a client included in a set of clients, a first function of a function split to be individually performed by the set of clients on client owned datasets;
receiving, at the client, a distortion function to be individually performed by the set of clients on individual results of the first function generated by the set of clients;
performing, at the client, the first function on a dataset owned by the client to produce an individual result;
performing, at the client, the distortion function on the individual result to produce a distorted result;
providing, by the client, the distorted result to a computing service that performs a second function of the function split using distorted results the first function generated by the set of clients; and
receiving, at the client, a return result generated by the computing service using the second function of the function split.

10. The computer-implemented method of claim 9, wherein performing the distortion function on the individual result further comprises:
coordinating with the set of clients to add random noise to the individual results of the first function.

11. The computer-implemented method of claim 10, wherein the client is a first client in a pair of clients, and the distortion function performed by the individual clients is a pairwise random number function comprising:
exchanging a random number between the first client and a second client;
adding, by the first client, the random number to an individual result generated by the first client using the first function; and
subtracting, by the second client, the random number from an individual result generated by the second client using the first function.

12. The computer-implemented method of claim 10, wherein the client is a first client in a pair of clients, and the distortion function performed by the individual clients is a pairwise random number function comprising:
exchanging a random number between the first client and a second client;
multiplying, by the first client using the random number, an individual result generated by the first client using the first function; and
dividing, by the second client using the random number, an individual result generated by the second client using the first function.

13. The computer-implemented method of claim 10, wherein the distortion function performed by the set of clients uses a common random number that is provided to each individual client in the set of clients, wherein each individual client in the set of clients applies the common random number to the individual results of the first function to generate the distorted results, and each individual client in the set of clients uses the common random number to remove a distortion from the return result of the second function.

14. A method comprising:
distributing, to a set of clients, a first function of a function split to be performed by individual clients included in the set of clients on individually owned datasets to generate individual results;
distributing, to the set of clients, a distortion function to be performed by the individual clients on the individual results of the first function to generate distorted results;
receiving, from the set of clients, the distorted results of the first function generated by the individual clients; and
performing a second function of the function split using the distorted results of the first function to produce a return result.

15. The method of claim 14, further comprising providing the return result of the second function to the set of clients.

16. The method of claim 14, wherein distributing the first function and the distortion function further comprises:
distributing a function split table and a distortion function table to the set of clients.

17. The method of claim 14, wherein the set of clients coordinate performance of the distortion function to add random noise to the individual results of the first function.

18. The method of claim 14, wherein the distortion function performed by the individual clients is a pairwise random number function comprising:
exchanging a random number between a pair of clients comprising a first client and a second client;
adding, by the first client, the random number to an individual result generated by the first client using the first function; and
subtracting, by the second client, the random number from an individual result generated by the second client using the first function.

19. The method of claim 14, wherein the distortion function performed by the individual clients is a pairwise random number function comprising:
exchanging a random number between a pair of clients comprising a first client and a second client;
multiplying, by the first client using the random number, an individual result generated by the first client using the first function; and
dividing, by the second client using the random number, an individual result generated by the second client using the first function.

20. The method of claim 14, wherein the distortion function performed by the individual clients uses a common random number that is provided to each individual client in the set of clients, wherein each individual client in the set of clients applies the common random number to the individual results of the first function to generate the distorted results, and each individual client in the set of clients uses the common random number to remove a distortion from the return result of the second function.
